(19) United States
(12) Patent Application Publication
(10) Pub. No.: US 2024/0070434 A1
(43) Pub. Date: Feb. 29, 2024

(54) CONVERSATIONAL KNOWLEDGE BASE

(71) Applicant: AI Netomi, Inc., San Mateo, CA (US)

(72) Inventors: Aditi Garg, Gurgaon (IN); Suchitra Gupta, New York, NY (US); Puneet Mehta, Orlando, FL (US); Partho Nath, Reno, NV (US); Nishant Pandey, Toronto (CA); Radha Yadav, Jaipur (IN)

(21) Appl. No.: 18/238,652

(22) Filed: Aug. 28, 2023

Related U.S. Application Data
(60) Provisional application No. 63/402,859, filed on Aug. 31, 2022.

(51) Int. Cl. G06N 3/006; G06F 40/30; G06F 40/58; G06N 3/0455

(52) U.S. Cl. CPC G06N 3/006; G06F 40/30; G06F 40/58; G06N 3/0455

(57) ABSTRACT

An information system provides a conversational knowledge base for responding to user queries. The information system incorporates contemporaneous advancements in NLP and deep learning to create the conversation knowledge base from its documents, which may be obtained from various sources. Domain-specific information is extracted and generated from the documents substantially without human intervention. From the domain-specific information, precise answers to synthesized questions are generated using transformer-based deep learning models.

### REFERENCE TO RELATED APPLICATIONS

The present application is related to and claims priority of U.S. provisional application (“Provisional Application”), Ser. No. 63/402,859, entitled “CONVERSATIONAL KNOWLEDGE BASE,” filed on Aug. 31, 2022. The disclosure of the Provisional Application is hereby incorporated by reference in its entirety.

### BACKGROUND OF THE INVENTION

### 1. Field of the Invention

The present invention relates to using natural language processing (NLP) techniques, large language models (LLMs), transformer-based, deep-learning models, and other techniques to train, analyze, extract and organize domain-specific information from a conventional knowledge base and other sources. Based on the domain-specific information, the present invention further provides an interactive system that responds user queries and that provides domain-specific services,

### 2. Discussion of the Related Art

In the detailed description herein, a “knowledge base” refers to an information system that provides domain-specific information. The knowledge base is typically constituted by a collection of documents, or other forms of information repository on any medium (e.g., audio and video files), that include information specific to a designated domain. The domain may be, for example, a particular business or a particular group of businesses (e.g., businesses within a specific industry). Generally, examples of documents supporting a knowledge base may include one or more websites, email messages, PDF files, or any combination of such documents.

Documents in a knowledge base may be developed for an audience external to the domain, an audience within the domain, or both. For example, a retail company may maintain an order management system that is configured to access both a customer-facing knowledge base and an internal knowledge base that is accessible only by persons—mostly employees—specifically authorized by the retail company. Both knowledge bases may include, for example, the retail company's refund policies.

In many industries, customer service consists primarily of furnishing basic information of a business to its customers. In other words, the role of customer service of a business is to fill gaps in the customers' knowledge concerning the business, especially gaps that frustrate customers from achieving their respective goals favorable to the business. For example:
At an on-line news source, a customer may seek clarity in the cost of a subscription to decide whether or not to subscribe.
At the on-line news source, another customer may want to know how soon after a cancellation, the on-line news service would complete the refund process.
At a shipping company, a customer may want to know if the shipping company serves a country into which the customer wishes to ship an article.

In the prior art, when a customer seeks any information, the customer is often directed to a specific portion of a knowledge base to find the information sought. That portion of the knowledge base may include, for example, a large document (e.g., a policy document) that requires significant time and effort to understand and, hence, entails an arduous process. As a result, rather than going through the arduous process, the customer often in the first instance resorts to a human customer service executive of the company to have his or her questions answered. The cost of providing such customer service is high. Even when the customer goes through the arduous process, customer satisfaction may be adversely impacted, especially when they fail to find the information sought in the specified portion of the knowledge base.

Thus, in the prior art, knowledge bases primarily merely allow a user to locate documents that potentially contain information sought by the user. However, as a customer typically seeks very specific information, the knowledge base fails the customer by leaving it to the customer to extract the information sought himself from an ordered list of documents returned. For example, when a user asks the question “Who has won the maximum individual medals in Olympics 2012?”— which desirably should elicit the response “Michael Phelps”—the user is instead typically presented with a list of relevant documents for he or she to explore. Naturally, such a process results in an unsatisfactory customer experience, and may even lead to frustration, when the answer sought is not found in the documents presented even after an arduous process.

Likewise, even though Question-Answering (QA) systems have evolved over many years, they still typically rely on rules, keywords, synonyms or pattern matching-based techniques to respond to a query Such methods limit the QA system to responding only to a limited set of anticipated questions. The results are often in low recall with at best average precision. Even though generative models based on artificial intelligence (e.g., GPT-4) have recently been applied to synthesize questions, the quality of the answers from a conventional QA system remains low.

Current knowledge base research is focused predominantly on creating open domain systems (i.e., generic systems that require customization to make the knowledge domain-specific). However, customer service systems are required by necessity to answer domain-specific questions. This disparity makes incorporating solutions from recent knowledge base research a challenge. Few knowledge base systems can be effective enough to serve a specific domain when constituted by a full spectrum of structured, semi-structured and unstructured open-domain information. As a result, customer service systems typically use siloed, unsalable solutions that require high maintenance at high operating costs.

### SUMMARY OF THE INVENTION

According to one embodiment of the present invention, an information system (“conversational knowledge base) capable of responding to user query incorporates contemporaneous advancements in NLP, LLMs and deep learning (e.g., transformer-based deep-learning models) to extract information from its documents. The conversational knowledge base significantly enhances end user experience by concisely presenting relevant information accurately and practically instantly. In one embodiment, a parser in the conversational knowledge base parses the documents from various sources to produce, substantially without human intervention, precise answers to synthesized questions using transformer-based deep learning models. Thus, a customer may discover relevant information without being required to navigate a large knowledge base themselves, thereby significantly improving customer experience.

In addition, a conversational knowledge base of the present invention is easier to train than a customer service system based on conventional topic-based algorithms. In one embodiment, owing to its extractive algorithms and heuristics, together with its custom-built answer-matching algorithms, a conversational knowledge base of the present invention generates higher quality and more accurate answers. Thus, a conversational knowledge base of the present invention provides a pleasant user experience from the perspectives of end-users (e.g., customers) and administrators alike. The end-user experience is enhanced by the system's prompt and precise responses, which are relevant information presented in compatible formats. At the same time, from the perspective of the administrator, a conversational knowledge base of the present invention may be set up quickly and provides transparency and smooth operational control. Many algorithms in a conversational knowledge base of the present invention are based on machine learning and artificial intelligence.

The present invention is better understood upon consideration of the detailed description below in conjunction with the accompanying drawings.

### BRIEF DESCRIPTION OF DRAWINGS

FIG. 1 shows flow chart 100 that illustrates the construction, training, and live operation of a conversational knowledge base, in accordance with one embodiment of the present invention.

FIG. 2 shows exemplary GUI 200, over which an administrator for a conversational knowledge base may define a source of textual information, in accordance with one embodiment of the present invention.

FIG. 3 shows exemplary GUI 300, over which an administrator for a conversational knowledge base may review the performance of the conversational knowledge base, in accordance with one embodiment of the present invention.

FIG. 4 is a functional block diagram of customer service system 500, which incorporates a conversational knowledge base, in accordance with one embodiment of the present invention.

### DETAILED DESCRIPTION OF THE INVENTION

According to one embodiment of the present invention, a conversational knowledge base may incorporate any domain-specific business information from any source business documents (e.g., frequently asked questions (“FAQs”), how-to guides, and trouble-shooting instructions). The conversational knowledge base may also allow a user to search for proposed solutions to problems likely encountered by participants in the domain, while alleviating the burden of reviewing a large number of documents by the user. Using algorithms of artificial intelligence (AI) and Human-AI interactions, the conversational knowledge base is configured to achieve, for example, the following features and goals:
a. answers to customer questions, in both long and short formats, using techniques of AI, thereby improving user communication and enhancing end-user experience;
b. question-answer pairs in the conversational knowledge base, synthesized using NLP from free-text website content, CSVs, PDFs, or Docs;
c. visibility and transparency into the AI system of the conversational knowledge base, so as to enable an administrator to review, validate, edit, approve or reject recommendations of the questions and answers in the conversational knowledge base;
d. a manual (i.e., under human supervision) or semi-supervised (i.e., AI-assisted) curation process for further processing of question-answer pairs, which allows—in addition to confirmation of the validity and the accuracy of the answers—policy and compliance requirements to be met;
e. a platform that enables an administrator to define personalized workflow-based responses and to customize transactional customer interactions based on detected customer “intents” (i.e., topics of interest);
f. templates into which answers may be embedded, which may be invoked at run-time; the templates may be parameterized to allow picking from various appropriate format (e.g., long form or short form), filling in the appropriate business entities or salutations (e.g., product names or customer names); templates enables:
   i. use of generated answer multi-step, personalized workflow responses, with various desired degrees of customization (e.g., additional greetings and follow-up steps, in addition to providing the answer); and
   ii. initiation of one or more feedback loops to accommodate different actions that can be taken (e.g., presenting additional options, answers, greater details);
g. an optimizer that tracks common, high-frequency or high-value questions in the query traffic and surfaces them for review; such an optimizer enables:
   i. further optimizations when handling such queries (e.g., further curation for the personalized workflow or question-answer pairs); and
   ii. conversion of frequently invoked question-answer pairs to classification-based, trained intents and responses that can be included in personalized workflows; the conversion reduces training effort, as only popular queries are recognized as trained intents, thereby enabling a faster deployment and ensuring a desirable curated customer experience;
h. “zero-day” launch support: automatic generation of question-answer pairs from conventional knowledge sources anticipate user behavior, thus allowing comprehensive customer support on the same day the platform or feature is launched, even when no historical training data or historical usage patterns are available to identify “common” or “popular” questions; “zero-day” launch support enables AI to participate in the earliest part of the customer support lifecycle, which is often human resource-intensive; and
i. a modular (“plug-in based”) architecture which creates a platform- and vendor-agnostic platform: any algorithm in the platform may be seamlessly replaced by a third-party implementation, as may be desirable on a given hosting platform, user preference, or due to any compliance, licensing needs.

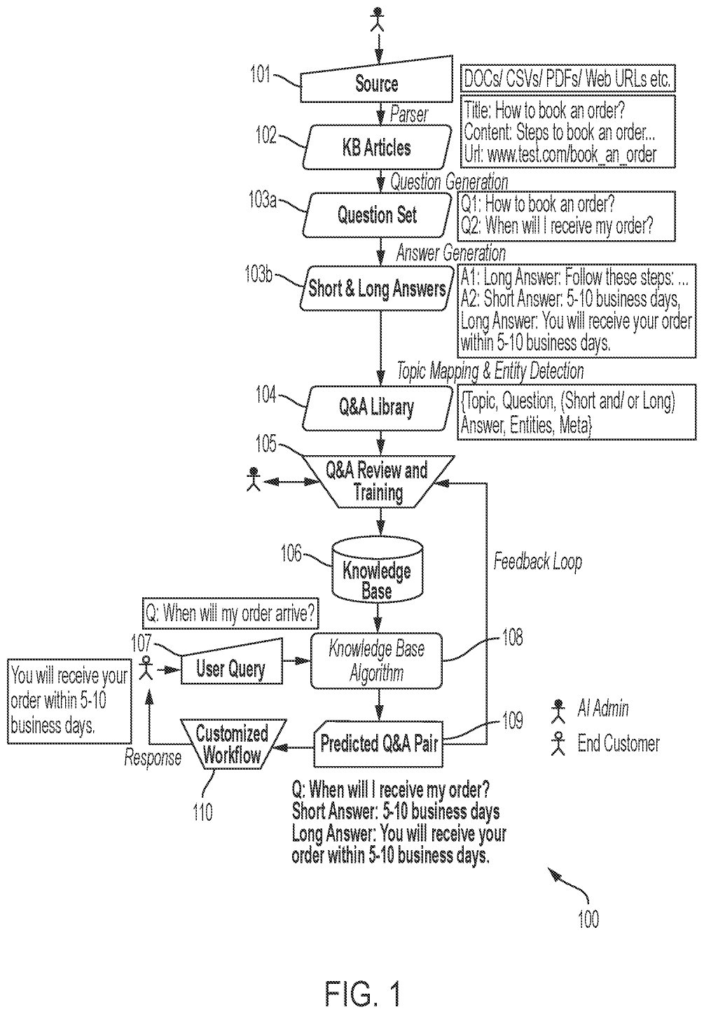

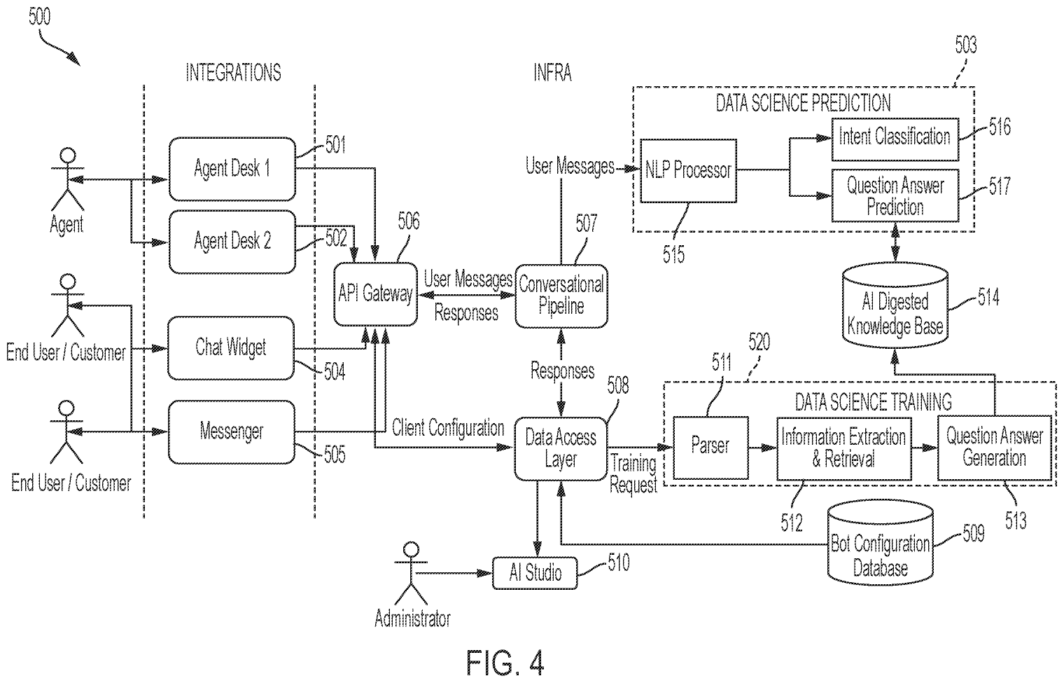

FIG. 1 shows flow chart 100 that illustrates the construction, training, and live operation of a conversational knowledge base, in accordance with one embodiment of the present invention. FIG. 4 is a functional block diagram of customer service system 500, which incorporates a conversational knowledge base, in accordance with one embodiment of the present invention.

As shown in FIG. 1, construction or enrichment of the conversational knowledge base begins at step 101 with collecting any combination of domain-relevant structured, semi-structured and unstructured information sources (e.g., private, public, or authentication-based websites and content, internal and external documents in any formats, whether static or live, audio files, video files, historical conversations between customers and agents, and postings in community forums). Examples of static documents include text, policy and FAQ documents (e.g., in .pdf, .docx, .xlsx, and .csv formats) and structured data files (e.g., in .xlsx and .xls formats). Examples of live documents include documents that are continuously being developed by multiple authors or entities in a collaborative manner (e.g., Google Docs, such as Google Sheet files), application program interfaces (e.g., to data in databases) and access means to on-line documents (e.g., customized URLs, such as links to customer service management system resources).

A conversational knowledge base of the present invention may offer a graphical user interface (GUI) to facilitate an administrator to gather documents at step 101. In customer service system 500 of FIG. 4, for example, the GUI may be accessed through application software 509 (e.g., AI studio) for configurating and training intelligent robots (“bots”). Application software 509 may be any suitable conventional AI-based software, as known to those of ordinary skill in the art. Application software 509 allows an administrator of customer service system 500 to access the conversational knowledge based through an application program interface (API) of data access layer 508. Typically, the administrator uses the GUI to create, review, update, or save bots maintained in customer service system 500. Configuration data of customer service system 500, including bots maintained in the system, are stored in configuration database 510.

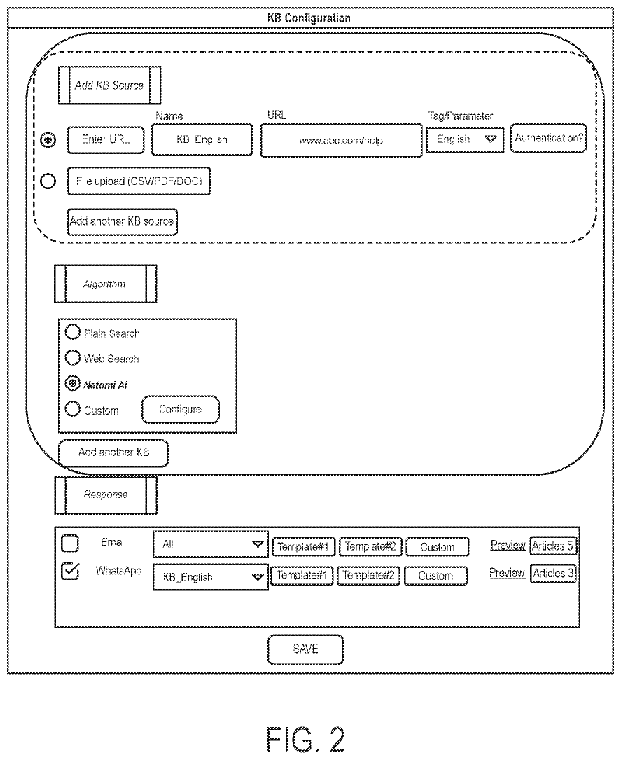

FIG. 2 shows exemplary GUI 200, over which an administrator for a conversational knowledge base may define a source of textual information, in accordance with one embodiment of the present invention. As shown in FIG. 2, the administrator may add, edit or delete multiple sources of documents for the conversational knowledge base.

Through application program 509 and an API of data access layer 508, an administrator can also manage the conversational knowledge base in customer service system 500. For example, at step 102 of FIG. 1, one or more parsers (e.g., parser 511 of FIG. 4) operate on the collected documents from the various sources to extract and classify the information contained in these collected sources into conversational knowledge base articles (e.g., title, content, universal resource locators (“URLs”), and meta information). The collected documents may be re-indexed as needed to facilitate subsequent processing.

The conversational knowledge base may utilize one or more data-extraction techniques (e.g., crawlers, scrapers and rich document readers) to extract structured and unstructured information from various data sources, as mentioned above. Open-source and other libraries (e.g., Selenium, Beautiful Soup, and Textract) may be used to extract data from different sources, including text sources. For uniformity and consistency, the parsed information is expressed substantially into four key types: title (i.e., subject area of interest or “key topic”), content, URL and meta information. In this regard, “content” refers to key text information. The other parsed information types are optional, unless they themselves represent content, as when extracted from certain sources. The conversational knowledge base parser may extract, merge and store the parsed information from any number or kind of sources. Each source may be periodically automatically refreshed at short intervals, so as to eliminate or reduce any manual intervention required to update the information of the conversational knowledge base. Additionally, the administrator also may define custom parsers to retrieve the required information. Any or all of these techniques and operations may be implemented in customer service system 500 of FIG. 4, as indicated therein as information extraction and retrieval module 512.

At steps 103a and 103b, the conversational knowledge base articles synthesize a diverse and exhaustive set of question-answer pairs. For example, based on the extracted information, question-answer pairs are generated in customer system 500 of FIG. 4 in question-answer generation module 513. These generated question-answer pairs are further organized at step 104 into a library or question-answer bank, with question-answer pairs grouped according to key topics to better manage the conversational knowledge base. In FIG. 4, for example, the library or question-answer bank may be implemented in AI-digested knowledge base 514. In one embodiment, an administrator may select among various machine-learned extraction algorithms to use in the conversational knowledge base, based on the administrator's preference.

According to one embodiment of the present invention, a question generation model—based on a custom or an open-source algorithm—generates a diverse and exhaustive set of close-ended or open-ended questions. For example, in one embodiment, the conversational knowledge base uses a transformer-based deep learning pre-trained-t5-small model, which is fine-tuned on the popular Squad dataset for end-to-end question generation. The transformer-based deep learning model may also be further fine-tuned on client-specific datasets for improved results. Fine-tuning may include extracting a list of consecutive pairs of sentences from the text and passing the extracted sentences into the model for use as context for the questions generated. Relevant context may also be extracted by tokenizing the available text. The set of generated questions may be refined or pruned, as desired, using a rule-based approach, for example, to exclude questions with low confidence scores, or to enhance the questions to a more desirable manner of speech (e.g., active or passive voice) to work with.

For a given collection of conversational knowledge base articles and questions extracted from sources in the conversational knowledge base, both short and long answers may be generated to each question using state-of-the-art deep learning-based answer retrieval algorithms. In one embodiment, short answers are first generated using maximum similarity (e.g., cosine, entailment measure) from text that is split into different relevant sections (e.g., divided into consecutive sentence sections, or into tokens or into characters). Each consecutive sentence section may be provided as context and as a potential long answer. The boundaries of a potential long answer may be refined using custom rule-based methods, as mentioned above. The machine representation (“embeddings”) used for selecting a relevant short answer may be expressed as a vector or as a transformer-based or custom embedding. For example, the conversation knowledge base may use embeddings based on multiQA-cosv1 to retrieve the most relevant short answer.

By automating the tasks of question generation and their answers, an exhaustive set of questions may be generated, which is virtually impossible if questions were manually added to the knowledge base one-by-one.

An administrator of a conversational knowledge base may be provided with an option to review and refine custom entities generated from a corpus of the knowledge using traditional and custom named entity recognition (NER) algorithms. In some embodiments, predefined global entities may be provided for operational ease. Such custom and global entities may be extracted from the question-answer pairs generated using a custom-built algorithm. The custom-built algorithm may extract the entities based on a context present in the utterance, for example. An administrator can then create customized response templates using the entity types as placeholders. The templates may be used by the conversational knowledge base to respond to customer queries by populating user-specific data into the entity placeholders at run-time.

AI may be used to generate various questions and answers. Operational controls are provided to review and approve generated questions and answers by the administrator. These pre-generated questions answers are used to respond to customer queries at the run time. Again, AI is used to find the closest answer to the customer query by looking at pre-generated questions and answers. Additionally, pre-generated answers can be short form, as well as long form. Depending on the conversation channel used, answers provided may vary. For example, short form answers may be used for a chat widget to meet the requirements for the user experience. Similarly, long form answers may be used if conversation takes place via email where long form text may be acceptable.

Question-answer pairs created are mapped into different topics of interest, so that similar question-answer pairs may be grouped into a cluster under the same topic and independently accessible apart from question-answer pairs of other topics. Clustering may be achieved using, for example, a clustering algorithm that leverages a discriminative clustering model. Super-clusters and sub-clusters, as understood by those of ordinary skill in the art, may also be created. Other algorithms (e.g., centroid-based, density-based, distribution-based, entity-based, and hierarchical clustering algorithms) may also be used for creating clusters of question-answer pairs. The topics are identified based on the distribution of keywords in each cluster. The set of question-answer pairs and corresponding topics are sent to the moderator for quality review, so that customers may receive high-quality and moderated answers. Furthermore, question-answer clustering allows the administrator to prioritize review and training based on the volume of clusters.

In summary, therefore, AI-digested knowledge base 514 in customer service system 500 of FIG. 4 may store the original knowledge base provided, AI-derived or extracted information (e.g., topics entities, questions and answers). The operational state of the information may also be included (e.g., the state of review by the administrator, or released to production use).

At step 105, the question-answer pairs are accessed for review, for supervised and unsupervised training, and for moderation by one or more administrators to ensure high-quality. In customer service system 500 of FIG. 4, for example, the administrator may conduct this process through application program 509 and an integrated API of data access layer 508. The approved question-answer pairs are saved into conversational knowledge base 106 along with any other relevant meta information available (e.g., titles, article links, entities, and additional similar questions). The moderation process enables machine-generated question-answer pairs to be reviewed before training takes place on the conversational knowledge base.

Conversational knowledge base 106 provides the bases for responding to customer queries (steps 107-110). Customers typically access a conversational knowledge base of the present invention through an application program that is integrated to the conversational knowledge base through, for example, an API. In customer service system 500 of FIG. 4, for example, a customer may use any of numerous customer service application programs or platforms to access the conversation knowledge base through API gateway 506, provided by Netomi Corporation. FIG. 4 shows customer service programs 502, and 503, representing commercially available customer service programs or platforms (e.g., “chat widget”). Additionally, a customer may also access the conversational knowledge base through a messaging program. As shown in FIG. 4, message program 505 integrates API gateway 506 to provide customer access over messages. As the conversational knowledge base may serve a large number of customers at the same time, conversation pipeline module 507 maintains orderly traffic and sequencing for the customer's, the agent's and the administrator's respective accesses to the conversational knowledge base.

When a customer query is received at step 107, NLP processor 515, using NLP techniques, calls upon user intent classification module 516 to determine the user's intent (e.g., to ask about tracking a delivery). Once the user's intent is ascertained, question-answer prediction module 517, operating various knowledge base search algorithms, identifies and retrieves from AI-digested knowledge base 514 candidate question-answer pairs suitable for responding to the customer's query. As illustrated in FIG. 1, knowledge base search algorithms at step 108 retrieve from conversational knowledge basis 106 relevant question and answer pairs. In one embodiment, knowledge base search algorithms transform the query into a machine representation (“embedding”), which is used as a template for retrieving the relevant question and answer pairs. In one embodiment, an administrator may be provided the ability to select between various machine-learned transformer models or solution versions in the conversational knowledge base, based on the administrator's preference.

According to one embodiment, a conversational knowledge base of the present invention responds to customer queries using an ensemble approach that ranks and outputs the best-matched question-answer pairs based on assessing: (i) query-answer semantic similarity and (ii) query-question semantic similarity to the synthesized question-answer pairs in the conversational knowledge base. For example, a best predetermined number of question-answer pairs are first obtained on the query-answer semantic similarity basis using, for example, a keyword-based search on the customer query—after applying on the customer query suitable pruning techniques (e.g., lower-casing, lemmatization, stemming and removal of stop words)—and ranking by a relevancy score. The conversational knowledge base then selects from the best predetermined number of question-answer pairs the answer that is most relevant to the customer query and that has a relevancy score exceeding a predetermined threshold. If no question can be selected on the query-answer semantic similarity basis, the same selection process is applied to the best question-answer pairs based on query-question similarity basis. If a relevant answer is still not found after selection using both semantic similarity bases, a predetermined number of relevant conversational knowledge base articles may be suggested to the customer to review, so as to avoid a human-handoff. At the customer's request, the customer query may be referred to a human agent, to ensure the customer receives a satisfactory resolution.

The agent may participate through any customer service platform that has access to the conversational knowledge base and that supports simultaneous interaction with the customer. For example, as illustrated in FIG. 4 by customer service system 500, an agent can use any of numerous customer service platforms (e.g., agent desk platforms 501 and 502). These customer service platforms may be integrated with API gateway 506 to allow an agent to access the conversational knowledge base and to interact with the customer.

FIG. 4 shows: (i) API gateway 506, which interacts with the outside world via agent desks 501 and 502, or other communication channels (e.g., chat interface 504 messenger interface 505); (ii) conversational pipeline 507, which interacts with API gateway 506, receiving messages; (iii) data science prediction system 503, which receives user messages from conversational pipeline 507, predicts end-user intent and finds relevant question-answer pairs; (iv) AI Studio 510, which is a graphical user interface-based (GUI-based) module, configures and trains the conversational knowledge base; (iv) data access layer 508, which is an API service for creating, reading, updating and saving knowledge base configurations through AI Studio 510, and (vi) AI digested knowledge base 514, which is a system that stores, optionally, the original knowledge base provided by the customer and AI-derived information. The AU-derived information may include topics, entities, questions and answers, and the operational state (e.g., the state of any review performed by the customer's administrator (“operation user”).

As shown also in FIG. 4, data access layer 508 allows the operation user to participate in training the conversational knowledge base. As shown in FIG. 4, data access layer 508 sends training requests to data science training unit 520. Data science training unit 520 includes parser 511, information extraction and retrieval unit 512 and question-answer generator 513.

As shown in FIG. 4, data science prediction system 503 includes NLP processor, which parses the user messages and communicates with the intent classification unit 516 and question-answer prediction unit 517. Intent classification unit 516 predicts a user intent from the messages. Based on the predicted user intent, question-answer prediction unit 517 retrieves relevant question-answer pairs. The knowledge base configurations processed by data access layer 508 are stored in configuration data base 509.

One of the retrieved question-answer pairs may either (i) be provided directly as a response to the customer, or (ii) upon recognizing the intent of the customer based on the customer query, channel the interaction with the customer into a customized workflow (step 109). The response to the customer may be in a short format (e.g., if the customer query is posed to a live interactive chatbot), or in a long format (e.g., if the customer query is posed in an email message, or any non-interactive format). The long format allows the response to be given in greater detail, for example, with cross-reference links to other relevant topics.

In one embodiment, as shown in FIG. 2, the administrator may create customized templates for formulating a response to the customer. For example, one template may provide a customer a personalized or customized style of response, based on the channel of interaction in which the customer poses the query, as mentioned above. Other options include activating logging of the question posed and the answer delivered, sending out web links along with the answer, and offering additional relevant answers and options of which the customer may be able to take advantage.

Besides answering the customer's query, the customized workflow may provide additional services at step 110 relevant to the intent of the customer. For example, if the customer query concerns when a refund would be paid after returning a product, the customized workflow would also take the customer into a sequence of steps to complete the product return process (e.g., taking the customer step-by-step from retrieving the purchase order up to and including printing a shipping label for returning the product by courier). As shown in FIG. 2, the administrator may be provided with a GUI to define the workflow interactions with a customer.

In one embodiment, the accuracy of the knowledge base search algorithms in assessing customer intent and the reception of the resulting response delivered to the customer may be fed back to review, moderation and training steps in step 105. As in the document gathering at step 101, the conversational knowledge base may offer a GUI for the administrator to efficiently moderate and monitor the positive impact on the end customers. Such feedback may be facilitated by a report generated in the conversational knowledge base. The report may include tracking metrics such as customer query or question posed, topic of interest, URL visited, question posed, long-form or short-form answer delivered, the source in the conversational knowledge base utilized and its identification, number of answers, articles or links displayed to the customer, number of answers, articles or links accepted (e.g., links followed) by the customer, ratings of the answers by the customer, feedback comment made by the customer, number of question-answer pairs reviewed, modified or deleted by an administrator. The administrator may be able to view, download or share the analytics report to help track and take necessary action to enhance the performance of the conversational knowledge. To facilitate the administrator, information in the analytics report may be selected using custom filters, based on variables such as time range, and data collection environment (e.g., live or test/sandbox utilization). Question-answer pairs based on customer reviews are then released by the administrator for use in future responses to customers.

In one embodiment, all answers to customer queries generated by the conversational knowledge base are sent to an administrator to review, along with the customer query, the identity of the customer, if known, and the circumstances under which the customer question is posed. The administrator may incorporate a reviewed answer for training and approval in the conversational knowledge base. Prior to incorporation, the administrator may edit both the incorporated customer query and the provided answer. In addition to enhancing the question-answer bank or library, the feedback loop allows machine learning to improve performance and the metrics by which the proposed answers can be ranked.

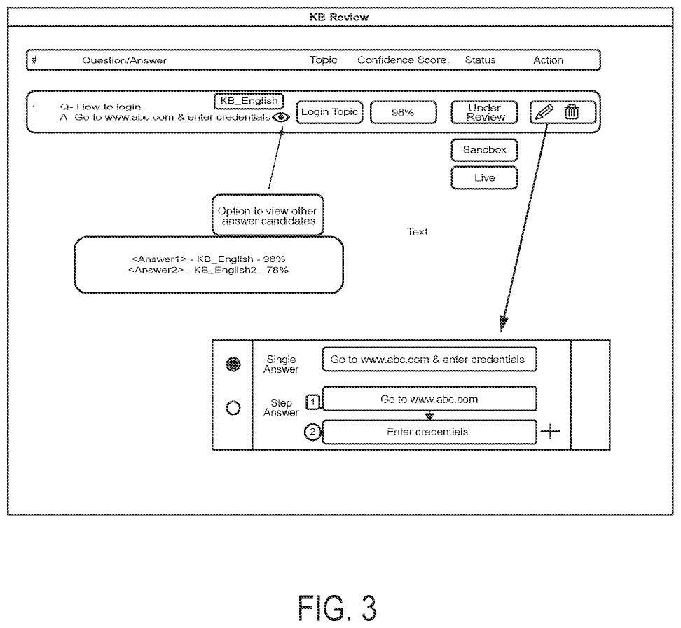

FIG. 3 shows exemplary GUI 300 over which an administrator of a conversational knowledge base may review the performance of the conversational knowledge base, in accordance with one embodiment of the present invention. For example, the administrator may (i) view any question-answer pair in a list of machine-generated question-answer pairs, along with additional details (e.g., machine model confidence scores and current status); (ii) based on expert knowledge, view and select new potential answers for a question, to create, revise, or delete question-answer pairs; (iii) accept and activate question-answer pairs for training and actual service to the customer; and (iv) reject or retire accepted question-answer pairs from service to customers. An administrator may also train question-answer pairs in a staging environment (“sandbox”) to test changes before the question-answer pairs may be provided to customers.

The administrator may also select question-answer pairs from the conversational knowledge base to perform a manual (i.e., under human supervision) or semi-supervised (i.e., AI-assisted) curation process. The curation process ensures that the curated question-answer pairs comply with policy and compliance requirements.

The administrator may also create templates into which answers may be embedded. These templates allow customization for use with different suitable situations at run-time. For example, in a situation where the long-form answer may be appropriate, and the template may be instantiated for that situation in the appropriate format. Likewise, a template may be instantiated for different business entities (e.g., different products) or for different customers. Templates are particularly useful for creation of generated answer multi-step, personalized workflow responses, that can be subsequently instantiated with various desired degrees of customization (e.g., additional greetings and follow-up steps, in addition to providing the answer) under different situations. Templates are also flexible when one or more feedback loops at different points of in workflow are required to accommodate different actions that can be taken (e.g., presenting additional options, answers, greater details), incorporating the contexts at those points in the workflow.

The administrator is provided an interface to an optimizer that allows the administrator to inspect high-volume or high-value queries, queries associated with specific topics, keywords or entities, or queries that conform to specific volume, usage or feedback profiles. Such queries are surfaced by the reporting, or other in-platform search or discovery tools. One example of a high-value query is a query that invokes one or more specific entities or keywords of interest, or a query that elicits a specific response, or a response that includes a specific resource (e.g., by identified by a specific URL, a specific webpage or document).

The optimizer is particularly useful when certain queries become high-volume unexpectedly. The optimizer also provides user-feedback that may prompt the administrator to offer the users different responses to the same query in a workflow, according to their preferences. Upon surfacing these queries and answers, the administrator may be provided different options to perform additional customization of the response. The optimizer identifies for the administrator the responses on which the administrator's efforts are best spent.

In one embodiment, the administrator may:
a. convert an automatically generated response to a curated form; the administrator may also update automatically generated response or refer the response to a qualified person for further curation or optimization.
b. enhance a curated response by further updating the curated response;
c. flag a response that includes specific content (e.g., a link to a customer-owned webpage or media), which prompts the interested party (e.g., the customer) to review the content for enhancement, such as when the optimizer identifies the response as to have been invoked in a high-volume query, a high-value query, or based on user feedback;
d. convert a response to a workflow based on the optimizer receiving user feedback; the administrator may offer the response as a conversational workflow in which the user may selected different options at different steps or points in the workflow, thereby receiving different customized answers according to the selected options; and
e. retrain selected question-answer pairs into intents or topics, especially when the occurrence of a certain question is frequent enough, or when the ways in which the same question may be asked is numerous enough (e.g., in such manner or using such terms beyond what exists in the source documentations); retraining a response to be an intent in a workflow allows for a fully customizable experience.

The conversational knowledge base of the present invention may incorporate a multi-lingual service to handle knowledge bases of multiple languages. The multi-lingual service may obtain translation of non-native language documents and index the translated native language versions (e.g., English). The translated versions may facilitate use by other services (e.g., other AI services) in, for example, generations of questions and answers.

When a non-native language document is encountered, the multi-lingual service may involve one or more translations of the documents to create a version of the document of a preferred language. This translation process ensures that the information within the document can be effectively processed and utilized for further processing.

At run time, the multi-lingual service may convert a non-English user question into English for processing. The response to the converted English question may be in English. The multi-lingual service may translate the English response to the user's language in which the question is posed.

The above detailed description is provided to illustrate specific embodiments of the present invention and is not to be taken as limiting. Numerous variations and modifications within the scope of the present invention are possible. The present invention is set forth in the following accompanying claims.

We claim:

1. A domain-specific information access system, comprising:
a conversational knowledge base comprising:
(a) one or more parsers that parses input information and extracts therefrom domain-specific information of an internal data representation format;
(b) one or more question-answer generation modules that generate from the domain-specific information question-answer pairs to allow query of domain-specific information represented by the question-answer pairs; and
(c) a repository for maintaining the generated question-answer pairs;
an administrative interface that allows an administrator to access the repository to retrieve, refine and improve the generated question-answer pairs;
a query processing module that, upon receiving a query, accesses the conversational knowledge base to retrieve one or more question-answer pairs responsive to the query; and
a user interface for allowing a user to supply the query, to provide the query to the query processing module and to provide domain-specific information to the user based on the retrieved question-answer pairs from the query processing module.

2. The domain-specific information access system of claim 1, wherein the query processing module comprises a natural language processing module that processes the query into a format suitable for detecting user intent.

3. The domain-specific information access system of claim 2, further comprising an agent interface that allows an agent to access the query processing module and to interact with the user.

4. The domain-specific information access system of claim 3, wherein the user interface, the agent interface and the administrator interface each comprise an application program interface to the conversational knowledge base.

5. The domain-specific information access system of claim 4, wherein the user interface, the agent interface and the administrator interface provide graphical user interfaces to the user, the administrator and the agent.

6. The domain-specific information access system of claim 5, wherein one or more of the user interface, the administrator interface and the agent interface are integrated through the application program interface with a commercial software platform.

7. The domain-specific information access system of claim 1, further comprising a question-answer selection module that, based on the detected user intent, selects and retrieves question-answer pairs from the conversational knowledge base.

8. The domain-specific information access system of claim 7, wherein the question-answer selection module selects the question-answer pairs based on an ensemble approach that ranks and outputs the best-matched question-answer pairs from the conversational knowledge base.

9. The domain-specific information access system of claim 8, wherein the question-answer pairs are ranked based on (i) query-answer semantic similarity and (ii) query-question semantic similarity to the synthesized question-answer pairs in the conversational knowledge base.

10. The domain-specific information access system of claim 9, wherein the query-answer semantic similarity is weighed higher than query-question semantic similarity.

11. The domain-specific information access system of claim 8, wherein the question-answer pairs are each qualified by a relevancy score that exceeds a predetermined threshold.

12. The domain-specific information access system of claim 1, wherein algorithms in the parsers of the conversational knowledge base apply artificial intelligence and human-artificial intelligence techniques to extract domain-specific information.

13. The domain-specific information access system of claim 1, wherein the question-answer generation module generates question-answer pairs using natural language processing techniques.

14. The domain-specific information access system of claim 1, wherein the input information comprises domain-relevant documents, whether structured and unstructured.

15. The domain-specific information access system of claim 14, wherein the domain-relevant documents comprise business documents, how-to guides, and trouble-shooting instructions.

16. The domain-specific information access system of claim 14, wherein the structured domain-relevant documents are provided in any of the following formats: free-text, website content, CSV, PDF, Docx and Docs.

17. The domain-specific information access system of claim 14, wherein the parsers classify the domain-relevant documents into two or more of the following categories: key topics, content, URLs, and meta-information.

18. The domain-specific information access system of claim 14, wherein a portion of the domain-relevant documents are refreshed at predetermined times.

19. The domain-specific information access system of claim 1, wherein the administrator interface allows an administrator to define personalized workflow-based responses, create templates for response to user query, and to customize transactional customer interactions.

20. The domain-specific information access system of claim 1, wherein the conversational knowledge base is organized according to intents to a plurality of libraries or one or more question-answer banks.

21. The domain-specific information access system of claim 1, wherein question-answer pairs in the conversational knowledge base are mapped into different topics of interest, and clustered according to similarity.

22. The domain-specific information access system of claim 17, wherein the clustered question-answer pairs are independently accessible according to topic of interest.

23. The domain-specific information access system of claim 1, wherein the conversational knowledge base is compiled or refined according using artificial intelligence and machine learning techniques.

24. The domain-specific information access system of claim 1, wherein at least one of the question-answer pair generation modules utilizes a transformer-based deep learning pre-trained model.

25. The domain-specific information access system of claim 1, wherein each question-answer pair comprises an answer that is presentable in either a short format or a long format.

26. The domain-specific information access system of claim 25, wherein the short format answer is first generated using maximum similarity from text that is split into different relevant sections.

27. The domain-specific information access system of claim 25, wherein consecutive sentences in the input information are provided as context and as an answer in long answer format.

28. The domain-specific information access of claim 1, wherein the administrative interface allows an administrator to access question-answer pairs for review, for supervised and unsupervised training, and for moderation.

29. The domain-specific information access system of claim 1, wherein the user interface allows multiple users to access the conversational knowledge base, the domain-specific information access system further comprises a conversation pipeline module that maintains orderly traffic and sequencing of user access.

30. The domain-specific information access system of claim 1 wherein the query processing module, upon retrieving a question-answer pair to a user query performs one or more of: (i) providing the retrieved question-answer pair as a response to the customer, and (ii) upon recognizing the intent of the customer based on the customer query, channeling the interaction with the customer into a customized workflow.

31. The domain-specific information access system of claim 1, further comprising a metric module that provides tracking metrics for one or more of: selected query or question posed, topic of interest, URL visited, question posed, long-form or short-form answer delivered, the source in the conversational knowledge base utilized and its identification, number of answers, articles or links displayed to the customer, number of answers, articles or links accepted by the user, ratings of the answers by the customer, feedback comment made by the user, and number of question-answer pairs reviewed, modified or deleted by an administrator.

32. The domain-specific information access system of claim 1, further comprising an optimizer module which allows the administrator access to one or more of: (a) queries having greater than a predetermined frequency of occurrence; (b) queries having greater than a predetermined value; (c) queries relating to any of specific topics, keywords, or entities; and (d) queries conforming to a specific profile.

33. The domain-specific information access system of claim 32, wherein the specific profile relates to any of: (a) frequencies of occurrence, (b) usage patterns, and (c) user feedback profiles.

34. The domain-specific information access system of claim 32, wherein the optimizer is configured to allow the administrator (a) convert an automatically generated response to a curated form, (b) update an automatically generated response; or (b) refer a response to a qualified person for further curation or optimization.

35. The domain-specific information access system of claim 32, wherein the optimizer is configured to allow the administrator to enhance a curated response.

36. The domain-specific information access system of claim 32, wherein the optimizer is configured to allow the administrator to flag a response according to a predetermined criterion.

37. The domain-specific information access system of claim 34, wherein the predetermined criterion relates to one or more of: (a) content of an interested; and (b) identification by the optimizer as to have been invoked in (i) a query with greater than the predetermined frequency of occurrence, (ii) a query with greater than the predetermined value, or (iii) based on user feedback

38. The domain-specific information access system of claim 32, wherein the optimizer is configured to allow the administrator to convert a response to a workflow based on user feedback.

39. The domain-specific information access system of claim 38, wherein the workflow is configured to allow a user to select different options at different steps or points in the workflow, thereby enabling the user to receive different customized answers according to the selected options.

40. The domain-specific information access system of claim 32, wherein the optimizer is configured to allow the administrator to retrain selected question-answer pairs into intents or topics.

41. The domain-specific information system of claim 40, wherein the optimizer identifies a selected question-answer pair to have the predetermined frequent of occurrence.

42. The domain-specific information system of claim 40, wherein the optimizer detects that the selected question-answer pair have been invoked in queries having context or terms beyond those existing in source documents.

43. The domain-specific information system of claim 1, further comprising a multilingual service for converting queries or responses between two or more languages.
